(19) United States
(12) Patent Application Publication
(10) Pub. No.: US 2006/0064349 A1
(43) Pub. Date: Mar. 23, 2006

(54) System and method for rewarding a seller of a computing device

(75) Inventors: Boyd Cannon Multerer, Seattle, WA (US); Cameron Ferroni, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/947,419

(22) Filed: Sep. 22, 2004

(51) Int. Cl. G06Q 30/00

(52) U.S. Cl. 705/14

(57) ABSTRACT

A system and method for rewarding sellers of computing devices involves receiving information that authorization to use a software product on a computing device has been obtained by a user of the computing device. The received information includes a unique identifier of the computing device. An identity of a seller of the computing device is then determined based at least in part on the received unique identifier. Remuneration is then provided to the seller of the computing device.

### FIELD OF THE INVENTION

This invention generally relates to methods for providing an incentive for a seller to sell the goods of a particular manufacturer, and more particularly, to a system and method for rewarding a seller of a computing device when a software product is subsequently licensed for use by a user of the computing device.

### BACKGROUND OF THE INVENTION

Currently, with respect to software products that are stored on physical media, such as a compact disk—read only memory (CD-ROM), digital versatile disk (DVD), floppy disk, or other removable storage medium, the license to use the software product is implied to travel with the media itself. Because of this, many users who are not rightfully licensed to use the software may use the software, while being either unaware of the need for a license or willfully ignoring the need for a license. For example, in some high piracy regions, a user is able to purchase unauthorized disks containing copies of computer software. Because the user has purchased a disk containing the software, there is an implication, at least to the user, that he is licensed to use that software, regardless of whether or not he has actually procured a proper license. This pirated software may be run on any appropriate computer without the user procuring a license to use that software. Piracy is a problem for many different types of software products, including application software, game software, software comprising movies or music, and other forms of multimedia content.

Co-pending, commonly assigned, U.S. patent application Ser. No. ______, filed ______, entitled “Licensing The Use Of Software On A Particular Cpu” (Attorney Docket: MSFT-4125/309219.01), which is incorporated herein by reference in its entirety, describes a new method for distributing and licensing software that helps to combat software piracy. According to the method described therein, software can be freely distributed on any suitable medium, but a computing device will not run the software until an authorization code has been obtained that “unlocks” the software for use on that particular computing device. This prevents unauthorized or unlicensed computing devices from using the software. In effect, the delivery of the software code is separated from the permission to run the software code. That is, owning the physical medium on which the software code resides no longer carries with it a license to use the software. The license must be purchased separately, before the software can run on the computing device.

As described in greater detail in the co-pending application, a user who desires to run a software program or product on his computing device obtains a copy of the software, typically on some physical medium, such as a CD-ROM or DVD, or via download from a network. The computing device on which the software is designed to execute will not permit the software to execute unless the user obtains a license, in the form of an authorization code, from an entity that provides such licenses. In one embodiment, either the user, or the computing device on behalf of the user, transmits a unique identifier associated with the computing device and an identifier associated with the software product to an activation control system operated by the entity. The user may, for example, provide the unique identifier and the product identifier to the activation control system via a telephone, kiosk, website, or other manual or electronic means. The activation control system confirms whether the user has paid for a license to use the software product (that transaction may occur separately or at the same time). If payment has been received, the activation control system generates an authentication code to be transmitted back to the user or to the user's computing device. The activation code can take different forms.

In one embodiment, the activation code is generated by the activation control system by generating a digital signature (using, for example, RSA signing, Elliptic Curve signing, or any other private/public key signing technique or system) of the unique identifier of the computing device and the software product identifier. This digitally signed value is then transmitted back to the user or the user's computing device. The computing device then verifies the signature using a public key that corresponds to the private key used to sign the identifiers. If the unique identifier and product identifier returned in the signature match the unique identifier of the computing device and the particular software product identifier, then the computing device permits the software to run on the computing device.

In another embodiment, the activation code is generated based on a “machine key” stored within the computing device during manufacture of the device. Preferably, the machine key is stored such that the user cannot easily determine it. For example, the key may be encrypted on the computing device. In this embodiment, the activation control system that issues authorization codes maintains a database, lookup table, or other storage mechanism that associates a computing device's unique identifier with its machine key.

When the user wants to run a particular software product on his or her computing device, the unique identifier associated with the computing device and the software product identifier are transmitted to the activation control system, as in the previous embodiment. The activation control system then looks up the corresponding machine key (symmetric key) from its database and computes a hash (e.g., a SHA-1 hash) of the machine key concatenated with the product identifier. The hash, or some portion of the hash, forms the activation code. The activation code is then provided to the user. At the user's computing device, a similar hash function is performed on the product identifier and machine key that resides in the computing device. If the computed hash matches the hash that forms the activation code, then the software product is activated and runs on the computing device.

Because the authorization code, i.e., the digital signature or computed hash, is not transmitted until it is confirmed that the user has paid for the license, the method prevents the unauthorized use of the software. And because the authorization process depends at least in part on the unique identifier of the computing device, the software product is licensed for use only on that computing device. The authorization code will not “unlock” the software for use on other computing devices.

Co-pending application, Ser. No. ______, filed ______, entitled “Licensing The Use Of Software To A Particular User” (Attorney Docket No.: MSFT-4124/309220.01), which is incorporated herein by reference in its entirety, describes a similar mechanism in which the authorization to use a particular software product is tied to a valid on-line account of a user. According to this method, an authorization code that “unlocks” a software product is issued to a user who is validly logged into a central service, such as an on-line gaming service. With the authorization code, the user will be able to run the software product on any computing device from which the user is currently logged into his or her account on the central service. While the use of the software product is effectively tied to the user's on-line account, information can be stored associating that account with either the computing device that the user used to create the account or the particular computing device on which the user is presently using the software. Both of the licensing mechanisms described above have the potential to affect the way software products are sold at retail.

Presently, publishers distribute software on physical media (such as CD-ROMs and DVDs) to retailers who then sell the software to end users. The software is typically accompanied by a “shrink-wrap” license that provides a license to the end user to run the software. Retailers may charge a significant amount for a software title. For example, a single game title for use with one of the commercially available game consoles can cost as much as fifty dollars ($50). Profit margins on the sale of software are often greater for a retailer than the margins on the computing devices on which the software runs, and software tends to be a much higher volume product than the computing devices that run the software.

With the new software licensing mechanisms described above, the physical media no longer carries with it the license to use the software. Physical media containing the “bits” or “code” of a software product are essentially worthless to an end user without an authorization code to activate the software on a particular computing device. Consequently, publishers can freely distribute disks containing a software product or provide the software for download over a network without the worry of software piracy. Only users who subsequently pay (e.g., $40-50) to receive an authorization code can use the software. Most likely, the manufacturer of a given brand of computing device may implement this form of licensing in its computing devices, and software publishers would cooperate in the new distribution and licensing mechanism. The manufacturer of the brand of computing device, who controls the assignment of unique identifiers (e.g., serial numbers) to each computing device during manufacture, preferably would maintain the activation control system and thus control the issuance of licenses, i.e., authentication codes, to end user devices. This has the potential to change the role of retailers in the software distribution process.

For example, using the new licensing mechanisms described above, a user can travel to a retail store to buy a particular software title. Instead of the traditional sale of a disk containing the desired software, which may retail for as much as fifty dollars ($50), the user may instead be able to purchase a disk containing the software “bits” for much less, e.g., five dollars ($5), with the understanding that the user must later pay a larger amount, e.g., forty dollars ($40), to obtain an authorization code to “unlock” the software for use on his computing device. After purchasing the low cost disk, the user heads home and inserts the disk in his computing device. The disk may include a demonstration mode that allows the user to run a portion of the software, perhaps enticing the user to purchase an activation code to enable full use of the software. To run the full version, the user may be instructed to enter a unique identifier (e.g., a serial number) of his or her computing device along with the title of the software and that information is then transmitted to an activation control system. According to the licensing mechanisms described above, the activation control system may then transmit an activation code back to the user (or provide some other way for the user to obtain the activation code, such as via telephone or via e-mail). Once obtained, the computing device will then verify the authentication code before enabling full use of the software on the computing device. The computing device may then store (preferably securely) some indication that the software product has been “unlocked” on that computing device, and the user can thereafter use the software on that device at any time.

As another example, suppose the day that a new software product is released, the user rushes to a retail store to purchase the software but finds that the retailer is sold-out of disks containing the software. However, the software “bits” may be made available for download from the Internet. The user can download the software and burn it onto an appropriate physical medium (such as a CD-ROM using a CD-ROM burner). The user would then insert the CD-ROM into his or her computing device to run the software and would follow the steps described above to activate the software. Again, the publisher that makes the software “bits” available for download over the Internet does not have to worry about piracy, because the downloaded software cannot run without proper authorization.

While the new licensing mechanisms described above help to combat software piracy and can be helpful to an end-user, one group that may perceive a negative impact from such licensing mechanisms is the traditional software retailer. With these new licensing mechanisms, the physical media containing the software “bits” of a product may be sold at retail for relatively low cost (e.g., $5). As compared to traditional software product sales, the profit margins on these new sales will be much less. Instead, the more significant transaction will be the subsequent purchase of a license to use the software product on a computing device that implements the new licensing mechanism. But that transaction likely will not be performed by the retailer. Consequently, the retailer may no longer reap the profits associated with the more traditional form of software sales. Because the retailer will profit less from this new form of software distribution, the new licensing mechanisms may create a disincentive for the retailer to sell the underlying brand of computing device that implements this new mechanism. That is, the retailer will be more inclined to want to sell computing devices for which software is sold in the traditional manner, because the retailer stands to profit much more from those traditional software sales.

Consequently, for the new licensing mechanisms described above to succeed, methods for providing incentives to retailers to sell computing devices that implement these new forms of software licensing will be needed. The present invention satisfies this need.

### SUMMARY OF THE INVENTION

The present invention is directed to a system and method for rewarding a seller of a computing device when a software product is subsequently licensed for use by a user of the computing device. When a sale of a computing device is completed by a seller, the seller provides a unique identifier of the computing device, such as a serial number, to an entity that stores information associating that computing device with the seller. When a user of the computing device subsequently obtains authorization (e.g., a license) to use a software product on the computing device, the unique identifier of the computing device on which the user has obtained authorization to use the software product is provided to the entity. The entity determines from the stored information an identity of the seller of that computing device. The entity then determines some form of remuneration to be provided to the seller of the computing device. Thus, the seller receives remuneration for a transaction involving a different product that occurs after the initial sale of the computing device. This may provide an incentive for sellers to sell computing devices for which such remuneration can be obtained, as it represents a continued stream of revenue associated with the initial sale of such computing devices.

Other features and advantages of the invention will become evident hereinafter.

### BRIEF DESCRIPTION OF THE DRAWINGS

The foregoing summary, as well as the following detailed description of the invention, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing device with respect to which aspects of the present invention may be practiced;

FIG. 2 is a block diagram of an exemplary environment in which the present invention may be embodied;

FIG. 3 is a flow diagram of one embodiment of a method that may be performed by a seller of a computing device, in accordance with one aspect of the present invention;

FIG. 4 is a flow diagram of one embodiment of an aspect of a method of rewarding a seller of a computing device when a software product is subsequently licensed for use by a user of the computing device, in accordance with the present invention; and

FIG. 5 is a flow diagram of one embodiment of another aspect of the method of the present invention.

### DETAILED DESCRIPTION OF THE INVENTION

Overview

The present invention is directed to a system and method for rewarding a seller of a computing device when a software product is subsequently licensed for use by a user of the computing device. The present invention may, for example, be employed by a manufacturer of computing devices that has implemented one of the licensing methods described above in which software can be prevented from running on computing devices produced by the manufacturer until a user obtains subsequent authorization to use the software. Such a manufacturer may employ the present invention to provide a greater incentive for sellers to sell computing devices in which such a licensing mechanism has been implemented.

According to the present invention, when a sale of a computing device is completed by a seller, the seller provides a unique identifier of the computing device, such as a serial number, to an entity that stores information associating that computing device with the seller. When a user of the computing device subsequently obtains authorization (e.g., a license) to use a software product on the computing device, the unique identifier of the computing device on which the user has obtained authorization to use the software product is provided to the entity. The entity determines from the stored information an identity of the seller of that computing device. The entity then determines some form of remuneration to be provided to the seller. Thus, the seller receives remuneration for a transaction involving a different product that occurs after the initial sale of the computing device. This may provide an incentive for sellers to sell computing devices for which such remuneration can be obtained, as it represents a continued stream of revenue associated with the initial sale of such computing devices.

Exemplary Computing Device

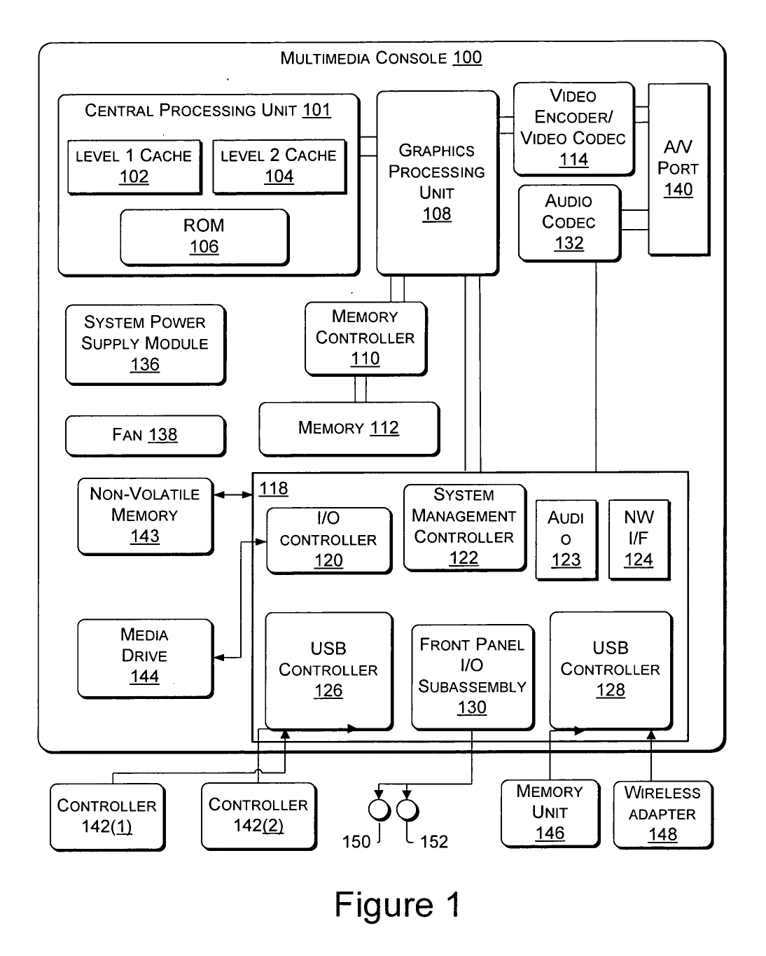

FIG. 1 illustrates the functional components of one example of a computing device with respect to which the present invention may be practiced. As used herein, the terms “computer,” “computer system,” and “computing device” refer to any device that comprises a processor capable of executing, presenting, or otherwise processing program code and/or data. As used herein, the terms “program code” and “code” refer to a set of instructions that are executed by a machine, such as a processor of a computing device. Examples of computing devices include, without any intended limitation, personal computers (PCs), servers, workstations, multimedia consoles, game consoles, satellite receivers, set-top boxes, arcade games, mobile telephones, personal digital assistants (PDAs), and other hand-held devices. The exemplary computing device of FIG. 1 comprises a multimedia console 100.

The multimedia console can run a variety of different software products. As used herein, the terms “software” and “software product” refer to any product that comprises instructions and/or data that can be executed, presented, or otherwise processed by a processor of a computing device, including without limitation, applications (e.g., word processors, spreadsheets, database systems, etc.), games, audio and video content, such as movies and music, and other multimedia content. It is understood, however, that the present invention may be implemented in the context of any type of computing device on which software products may be licensed for use.

The exemplary multimedia console 100 of FIG. 1 has a central processing unit (CPU) (sometimes also referred to as “processor”) 101 having a level 1 cache 102, a level 2 cache 104, and a ROM (Read Only Memory) 106. The level 1 cache 102 and level 2 cache 104 temporarily store data and hence reduce the number of memory access cycles, thereby improving processing speed and throughput. The CPU 101 may be provided having more than one core, and thus, additional level 1 and level 2 caches 102 and 104. The ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a random access memory (RAM).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CDROM/DVD drive, removable media, etc.). The network interface 124 and/or wireless adapter 148 provide access to a network (e.g., the Internet, home network, etc.) and may be any of a wide variety of wired or wireless interface components including an Ethernet card, a modem, a Bluetooth module, a cable modem, and the like.

A non-volatile memory 143 is provided to store application data that is loaded during the boot process. A media drive 144 is provided and may comprise a DVD/CDROM drive, hard drive, or other drive that receives some form of removable, or portable media such as, without limitation, CDROMs, DVDs or other optical media, memory cards, memory sticks, magnetic cassettes, magnetic tape, magnetic disks or other magnetic media. The media drive 144 may be internal or external to the multimedia console 100. Software products may be loaded or accessed via the media drive 144 for execution, presentation, playback, or other processing by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered ON, program code and data may be loaded from the non-volatile memory 143 into memory 112 and/or caches 102, 104 and executed on the CPU 101. Application program code may present a graphical user interface that provides a consistent user experience when navigating to different software available on the multimedia console 100. Software loaded into the media drive 144 may be launched, executed, presented, or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

The multimedia console 100 preferably has a unique identifier associated with it, such as a serial number, that can be used to uniquely identify the console 100. The unique identifier may be affixed to the console 100 or to packaging (not shown) associated with the console 100. For example, the unique identifier may be encoded as a bar code affixed to the console 100 or to its packaging.

Exemplary Embodiments

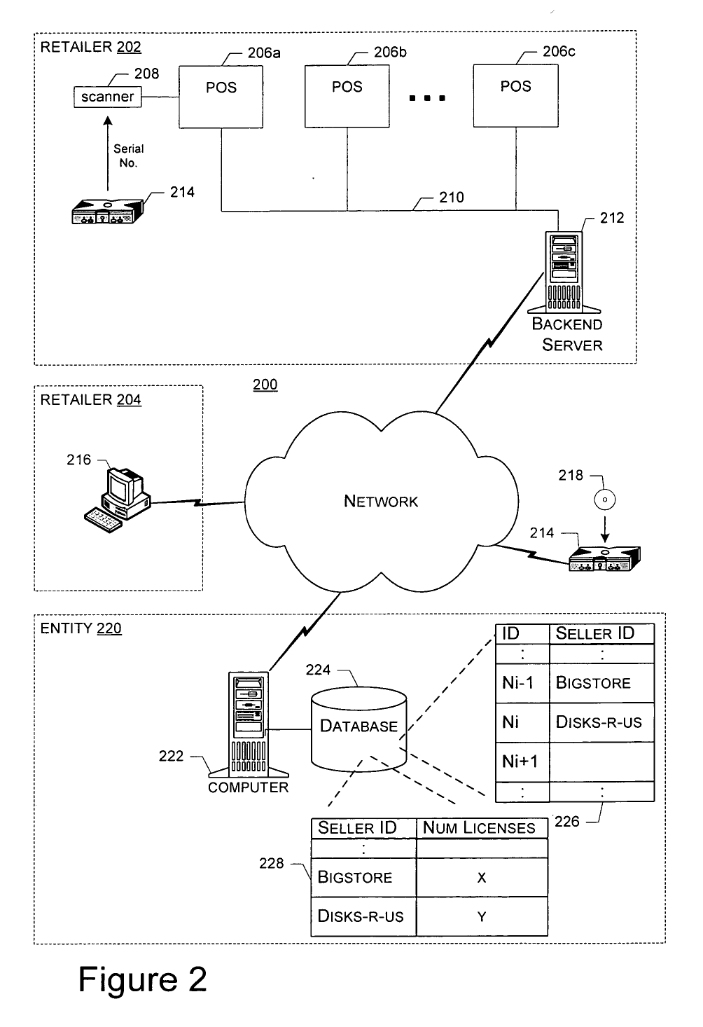

FIG. 2 is an exemplary environment 200 in which the present invention may be embodied. As shown, a plurality of sellers may sell goods to consumers, including computing devices of the type described herein. As used herein, the term “seller” refers to any person or entity who sells a thing or property, such as a computing device or a software product, in exchange for other property (typically money). In the exemplary environment, sellers 202 and 204 are both retailers of computing devices and software products. Retailers can include any person or entity that sells goods at retail, including large retail chains, such as Best Buy Co., Inc., Wal-Mart Stores Inc., and Circuit City® Stores, Inc., and smaller sole proprietors. Other sellers (not shown) can also operate in the exemplary environment 202 of FIG. 2, including wholesalers and manufacturers who sell directly to consumers.

One retailer, such as retailer 202, may operate a plurality of point-of-sale terminals 206a, 206b . . . 206c, at which sales transactions are conducted. When a transaction is completed, information concerning the transaction may be provided via a local area network 210 to a backend server 212 operated by the retailer. Each POS terminal 206a-c typically includes an optical scanner, such as optical scanner 208, for scanning bar codes on products purchased by a consumer. As described below, such a scanner 208 may be used for scanning a unique identifier (e.g., a serial number) of a computing device 214 that a consumer may purchase from the retailer. Another retailer, such as retailer 204, may not have as sophisticated a transaction system as a larger retailer 202. Both retailers, however, may have the ability to communicate information concerning a sales transaction over a network 230, such as the Internet.

Once purchased, the computing device 214 may be operated by a user. The user may, for example, purchase a software product 218 to use with the computing device. The computing device 214 may be connected to the network 230.

In accordance with the present invention, the exemplary environment 200 may further comprise an entity 220 that performs certain aspects of a method of compensating a seller of a computing device when a user subsequently obtains authorization to use a software product on the computing device. The entity may implement the method in a computer system 222. As shown, the computer system 222 may comprises a database 224 that stores information that associates the unique identifier (ID) of each computing device that has been sold with the identity of the seller (Seller ID) of that computing device. Such information may be stored, for example, in the form of a table 226. The computer system 222 may further store in the database 224 information indicating, for each seller of such computing devices, the number of software products for which authorization (i.e., a license) has been obtained by users of computing devices sold by that seller. Such information may be stored, for example, in another table 228 of the database. Each seller may then receive remuneration from the entity 220 based on such information.

The entity 220 may comprise a manufacturer of computing devices, a publisher of software products, or any other person or entity that desires to reward sellers of computing devices when software products are subsequently licensed for use on those computing devices. The entity 220 may also comprise the same entity that operates an activation control system such as that described in co-pending application Ser. Nos. ______ (Attorney Docket No. MSFT-4125/309219.01) and ______ (Attorney Docket No. MSFT-4124/309220.01). As described above, such an activation control system may provide authorization to use a software product on a particular computing device, or alternatively, the authorization may be tied to a valid on-line service account of the user, such that the user is authorized to use the software on any computing device from which the user is logged into his or her account with the on-line service. In one embodiment, the computer system 222 may be part of such an activation control system. In other embodiments, the computer system 222 may be separate from such an activation control system.

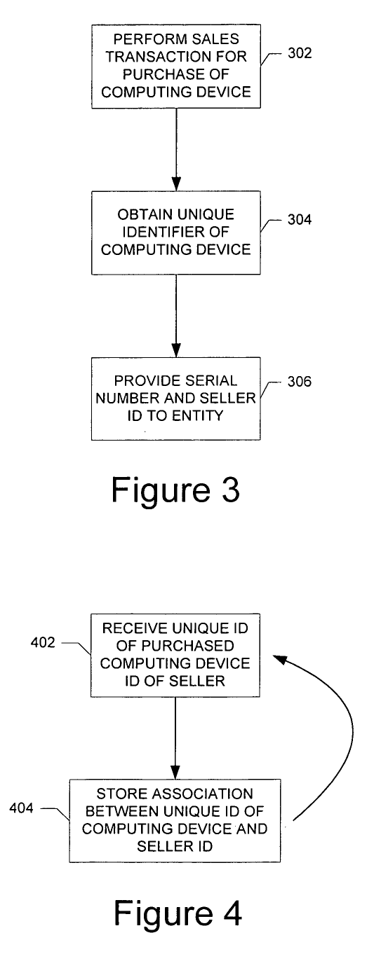

FIG. 3 is a flow diagram of one embodiment of a method that may be performed by a seller of a computing device, such as retailers 202 and 204, in accordance with one aspect of the present invention. At step 302, the seller performs a sales transaction involving the sale of a computing device to a purchaser. The sale may, for example, be performed by a sales clerk at a POS terminal of a retail establishment.

At step 304, a unique identifier of the computing device, such as a serial number, is obtained. This step can be performed in a variety of ways. For example, the step can be performed manually by reading the serial number from the computing device or a package containing the computing device, or it can be performed automatically using an optical scanner to scan a bar code in which the serial number has been encoded. As yet another example, a radio frequency identification (RFID) tag may be placed on or in the computing device, or on or in the computing device packaging, that emits a signal reflective of the unique identifier of the computing device. Such a signal could be automatically received by a suitable receiver at the point of sale. This would eliminate any manual steps needed to obtain the serial number. Also, placing the RFID tag within the housing of the computing device would make it easier to obtain the serial number again after the device has been refurbished or resold.

At step 306, the unique identifier of the computing device is then provided to the entity 220 (FIG. 2) along with an identifier of the seller. Again, the unique identifier of the computing device and the identifier of the seller can provided to the entity 220 in a variety of ways. For example, in the case of the large retailer 202 of FIG. 2 that employs a plurality of POS terminals 206a-c to record sales transactions to a backend server 212, the unique identifier of every computing device sold by that retailer can be scanned at the point of sale (e.g., optically or via RFID tag) and transmitted to the backend server 212. The backend server can then transmit the unique identifiers of each computing device sold by the retailer 202, along with the identity of the retailer, to the entity 220 via a network 230, such as the Internet. Such transmission could occur immediately upon the sale of a computing device, or alternatively, the backend server 212 could collect multiple sales transactions and then transmit the information to the entity 220 at predetermined intervals.

A smaller retailer, such as retailer 204, may not have as sophisticated a system. In such a case, the retailer may transmit the unique identifier of each computing device sold by that retailer to the entity 220 using a computer system 216 connected to the network 230. For example, entity 220 could host a seller website that the seller could access using the computer system 216. The seller could then navigate to a web page that presents a form that allows the seller to enter the unique identifier(s) of a computing device(s) sold by the seller. Various aspects of this process could also be automated. It is understood that a variety of methods can be employed to provide the entity 220 with the unique identifier of a computing device and an identity of the seller of that device, and the present invention is by no means limited to any one method.

FIG. 4 is a flow diagram of one embodiment of a method that may be performed by an entity, such as entity 220 of FIG. 2, in accordance with another aspect of the present invention. The method illustrated in FIG. 4 may, for example, be implemented in the form of an application that runs on the computer system 222 operated by the entity 220.

At step 402, information comprising the unique identifier of a computing device that has been sold, along with an identifier of the seller of the computing device, is received. Such information may have been transmitted by a seller, such as retailer 202 or retailer 204, using any of the methods described above.

At step 404, the received information is stored in a database that maintains an association between the unique identifier of the computing device and the seller of the computing device. The information may, for example, be stored in the form of a table, such as the table 226 illustrated in FIG. 2, in which each entry in the table provides the unique identifier (ID) of a computing device and an identifier (Seller ID) of the seller of that computing device. This process may then be repeated whenever other information concerning other computing device sales is received.

It is contemplated that a computing device may be returned to the manufacturer at some point, where it will be refurbished and then resold through a secondary channel, albeit with the same unique identifier (e.g., the same serial number). Preferably, upon resale of the refurbished device by a different seller, the stored association between the unique identifier and the original seller is replaced with a new or modified entry that associates the unique identifier with the new seller. For example, in one embodiment, if it is determined in step 404 that an entry already exists for the unique identifier received in step 402, the existing seller identifier in the database entry is replaced by the newly received identifier of the second seller.

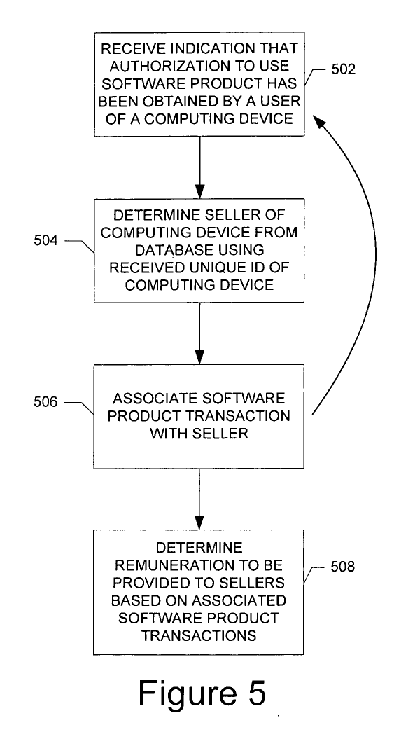

FIG. 5 is a flow diagram of one embodiment of another method that may be performed by the entity 220 in accordance with a further aspect of the present invention. Again, the steps of the method illustrated in FIG. 5 may be implemented in the form of an application that runs on the computer system 222 operated by the entity 220.

At step 502, information is received that indicates that authorization to use a software product has been obtained by a user of a computing device. The information includes the unique identifier of the computing device. The information may also include an identification of the software product for which authorization was obtained.

The information may be received from an activation control system such as that described in either of the aforementioned co-pending applications. The software product may have been licensed solely for use on the computing device identified by its unique identifier in the received information. Alternatively, the software product may have been licensed for use by a particular user having a valid account with an on-line service provider, in which case the computing device identified by its unique identifier in the received information may be any computing device associated with the user of that on-line account. For example, the identified computing device may be the computing device from which the user created the on-line account, or the identified computing device may be the computing device from which the user was logged onto the user's account at the time authorization was requested. Alternatively, the identified computing device can be some other computing device associated with the user's on-line account.

Next, at step 504, the received unique identifier is used to obtain the identity of the seller of the computing device. For example, the unique identifier may be used as an index into the table 226 of the database 224 of FIG. 2 to obtain an identifier of the seller.

At step 506, information about the software product transaction (i.e., the licensing of the software product by a user of the identified computing device) is recorded and associated with the identified seller. In one embodiment, as illustrated in FIG. 2, the database 224 of the computer system 222 may maintain a table 228 in which each entry represents a different seller of computing devices. The entry may include a unique identifier of the seller (Seller ID) and the number of software products for which licenses have been obtained on computing devices sold by that seller. Thus, in step 506, the number of licenses stored for the identified seller may be incremented. In other embodiments, other information can be stored. For example, more specific information about each software product transaction can be stored, such as an identification of the particular software product for which authorization was obtained.

Steps 502 through 506 can be repeated as information concerning other software product transactions is received. For example, these steps can repeated over predetermined billing cycles to accumulate information regarding software product transactions that occur during each billing cycle.

At step 508, an amount of remuneration to be provided to one or more sellers is determined based on the information received in steps 502 through 506. The remuneration can take a variety of forms and can be based on a variety of factors. The remuneration can be provided to the sellers by the entity 220, or a third party can be employed to handle payment of the remuneration.

In one embodiment, the remuneration may comprise a percentage of the payment made by a user to obtain authorization to use a software product on an identified computing device. Such remuneration could be provided to sellers at predetermined intervals, such as once a month or semi-annually. Alternatively, such remuneration could be provided to a seller immediately upon receipt of information indicating that authorization to use the software product has been obtained. For example, suppose that a user pays $40 to “unlock” (i.e., obtain authorization to use) a software product for use on a computing device. The seller of the computing device may be paid a 5% commission on that price. The payment can be made to the seller immediately, or such commissions can be summed over a predetermined billing cycle and then paid at corresponding intervals. purchase price of stored in the FIG. 5 is a flow diagram of another aspect of a method of rewarding a seller of a computing device when a software product is subsequently licensed for use by a user of the computing device, in accordance with one embodiment of the present invention.

In another embodiment, the total revenue from all software product authorizations can be summed and then the total divided among the sellers. The division could be based on the relative numbers of software product activations obtained on computing devices sold by each seller, or alternatively, the total could simply be divided by the total number of computing devices sold by each seller. Preferably, this form of remuneration would be provided at periodic intervals based, for example, on the total revenue over a predetermined billing cycle, e.g., once per month, once per quarter, semi-annually, or annually.

In yet other embodiments, the remuneration may be paid in the form of either a credit against future wholesale purchases of computing devices by a given seller, or in the form of discounts on future wholesale purchases of computing devices by the seller. As another possibility, where the entity providing remuneration is itself a vendor of software products or a provider of various services, the remuneration may be provided to the seller in the form of credits or discounts applied to purchases of software (including both software resold by the seller to end users and software that a seller may use for its own purposes) or services provided by the entity. The present invention is not limited to any one form of remuneration.

In one embodiment, steps 502 through 508 are only performed for a predetermined period of time after the initial sale of a computing device by a seller. That is, remuneration will only be provided to the seller for subsequent software authorizations obtained by a user of the computing device within a predetermined period of time after the initial sale of the computing device to the user. For example, remuneration may only be provided to the seller of the computing device for software authorizations obtained within the first year, or the first two years, after the initial sale of the computing device to the user. After that period, the seller does not receive remuneration for any additional software product authorizations. The predetermined period of time over which remuneration will be provided may be the same for each seller, or it may vary from seller to seller. Any predetermined period of time can be implemented, whether in days, weeks, months, or years.

As the foregoing illustrates, the present invention is directed to systems and methods for rewarding a seller of a computing device when a software product is subsequently licensed for use by a user of the computing device. All or portions of the system and method of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, wherein when the program code is loaded into and executed by a machine, such as a computer, the machine becomes an apparatus for practicing the invention. Computer readable media include, but are not limited to, RAM, ROM, EEPROM, flash memory or other memory technology, CDROM, digital versatile disks (DVD) or other optical disk storage, memory cards, memory sticks, magnetic cassettes, magnetic tape, magnetic disk storage or other magnetic storage devices, or any other medium which can be used to store the program code. The program code may be implemented in a high level procedural or object oriented programming language. Alternatively, the program code can be implemented in an assembly or machine language. In any case, the program code may be executed in compiled form or via interpretation.

It is understood that changes may be made to the embodiments described above without departing from the broad inventive concepts thereof. Accordingly, it is understood that the present invention is not limited to the particular embodiments disclosed, but is intended to cover all modifications that are within the spirit and scope of the invention as defined by the appended claims.

What is claimed is:

1. A method comprising:
receiving information indicating that authorization to use a software product on a computing device has been obtained by a user of the computing device, the information including a unique identifier of the computing device; and
determining based at least in part on the received unique identifier of the computing device, an identity of a seller of the computing device.

2. The method recited in claim 1, further comprising storing, for each of a plurality of computing devices, information associating a unique identifier of the computing device with an identity of a seller of the computing device, wherein said determining step utilizes the stored information to identify the seller of the computing device having the received unique identifier.

3. The method recited in claim 2, further comprising receiving the information associating a unique identifier of a computing device with the identity of the seller of the computing device from the seller.

4. The method recited in claim 3, wherein the information associating a unique identifier of a computing device with the identity of the seller of the computing device is received via a network over which the seller transmits the information.

5. The method recited in claim 3, wherein the information associating a unique identifier of a computing device with the identity of the seller of the computing device is received via a website hosted for the seller that the seller uses to provide the information.

6. The method recited in claim 1, further comprising determining an amount of remuneration to be provided to the seller based at least in part on the received information.

7. The method recited in claim 6, wherein the remuneration is a percentage of an amount paid by the user to obtain the authorization to use the software product on the computing device.

8. The method recited in claim 6, wherein the remuneration is a credit toward future wholesale purchases of computing devices by the seller.

9. The method recited in claim 6, wherein the remuneration is a discount against future wholesale purchases of computing devices by the seller.

10. The method recited in claim 6, further comprising repeating the steps of receiving and determining each time authorization to use a software product on a computing device sold by the seller is obtained by a user, and accumulating the amount of remuneration over a predetermined period of time.

11. The method recited in claim 10, wherein the amount of remuneration to be provided to the seller is determined based on the total number of authorizations obtained by users to use software products on computing devices sold by the seller.

12. The method recited in claim 10, wherein the amount of remuneration to be provided to the seller is determined based on the total number of computing devices sold by the seller on which users have obtained authorization to use software products.

13. The method recited in claim 1, further comprising repeating the receiving and determining steps each time that authorization to use a software product on a computing device is obtained by a user.

14. The method recited in claim 13, further comprising storing, for each of a plurality of sellers, information indicating a number of times that authorization to use software products on computing devices sold by the seller are obtained by users of those computing devices.

15. A computer-readable medium on which program code is stored, the program code, when executed on a computer system, causing the computer system to perform the following steps:
receiving information indicating that authorization to use a software product on a computing device has been obtained by a user of the computing device, the information including a unique identifier of the computing device; and
determining based at least in part on the received unique identifier of the computing device, an identity of a seller of the computing device.

16. The computer-readable medium recited in claim 15, wherein the program code further causes the computer system to store, for each of a plurality of computing devices, information associating a unique identifier of the computing device with an identity of a seller of the computing device, and wherein said determining step utilizes the stored information to identify the seller of the computing device having the received unique identifier.

17. The computer-readable medium recited in claim 16, wherein the program code further causes the computer system to receive the information associating a unique identifier of a computing device with the identity of the seller of the computing device from the seller.

18. The computer-readable medium recited in claim 17, wherein the program code further causes the computer system to host a website for the seller that the seller can use to provide the information associating a unique identifier of a computing device with the identity of the seller.

19. The computer-readable medium recited in claim 15, wherein the program code further causes the computer system to determine an amount of remuneration to be provided to the seller based at least in part on the received information.

20. The computer-readable medium recited in claim 19, wherein the remuneration is a percentage of an amount paid by the user to obtain the authorization to use the software product on the computing device.

21. The computer-readable medium recited in claim 19, wherein the remuneration is a credit toward future wholesale purchases of computing devices by the seller.

22. The computer-readable medium recited in claim 19, wherein the remuneration is a discount against future wholesale purchases of computing devices by the seller.

23. The computer-readable medium recited in claim 19, wherein the program code further causes the computer system to repeat the steps of receiving and determining each time authorization to use a software product on a computing device sold by the seller is obtained by a user, and to accumulate the amount of remuneration over a predetermined period of time.

24. The computer-readable medium recited in claim 23, wherein the program code causes the computer system to determine the amount of remuneration to be provided to the seller based on the total number of authorizations obtained by users to use software products on computing devices sold by the seller.

25. The computer-readable medium recited in claim 23, wherein the program code causes the computer system to determine the amount of remuneration to be provided to the seller based on the total number of computing devices sold by the seller on which users have obtained authorization to use software products.

26. The computer-readable medium recited in claim 15, wherein the program code further causes the computer system to repeat the receiving and determining steps each time that authorization to use a software product on a computing device is obtained by a user.

27. The computer-readable medium recited in claim 26, wherein the program code further causes the computer system to store, for each of a plurality of sellers, information indicating a number of times that authorization to use software products on computing devices sold by the seller are obtained by users of those computing devices.

28. A computer system comprising:
a database that stores, for each of a plurality of computing devices, information associating a unique identifier of the computing device with an identity of a seller of the computing device; and
an application that executes on the computer system and that receives information indicating that authorization to use a software product on a computing device has been obtained by a user of the computing device, the information including a unique identifier of the computing device, and that determines from the database an identity of the seller of the computing device based on the received unique identifier.

29. The computer system recited in claim 28, wherein the computer system hosts a website for the seller that the seller can use to provide the information associating a unique identifier of a computing device with the identity of the seller.

30. The computer system recited in claim 28, wherein the application further determines an amount of remuneration to be provided to the seller based at least in part on the received information.

31. The computer system recited in claim 30, wherein the remuneration is a percentage of an amount paid by the user to obtain the authorization to use the software product on the computing device.

32. The computer system recited in claim 30, wherein the remuneration is a credit toward future wholesale purchases of computing devices by the seller.

33. The computer system recited in claim 30, wherein the remuneration is a discount against future wholesale purchases of computing devices by the seller.

34. The computer system recited in claim 30, wherein the application repeats the steps of receiving and determining each time authorization to use a software product on a computing device sold by the seller is obtained by a user, and accumulates the amount of remuneration over a predetermined period of time.

35. The computer system recited in claim 34, wherein the application determines the amount of remuneration to be provided to the seller based on the total number of authorizations obtained by users to use software products on computing devices sold by the seller.

36. The computer system recited in claim 34, wherein the application determines the amount of remuneration to be provided to the seller based on the total number of computing devices sold by the seller on which users have obtained authorization to use software products.

37. The computer system recited in claim 28, wherein the application repeats the receiving and determining steps each time that authorization to use a software product on a computing device is obtained by a user.

38. The computer system recited in claim 37, wherein the application stores, for each of a plurality of sellers, information indicating a number of times that authorization to use software products on computing devices sold by the seller are obtained by users of those computing devices.

39. A method performed by a seller of a computing device, comprising:
completing a sale of a computing device; and
providing a unique identifier of the computing device, along with an identifier of the seller, to an entity that provides remuneration to the seller when authorization to use a software product on the computing device is subsequently obtained by a user of the computing device.

40. The method recited in claim 39, wherein the unique identifier of the computing device and the identifier of the seller are provided to the entity by transmission over a network.

41. The method recited in claim 39, wherein the unique identifier of the computing device and the identifier of the seller are provided via a website hosted by the entity.

42. The method recited in claim 2, further comprising modifying the stored information associating a unique identifier of a computing device with an identity of a seller when the computing device is subsequently resold by a second seller, so that the unique identifier is associated with the identity of the second seller.

43. The method recited in claim 6, wherein the remuneration comprises a discount against purchases of other software products or services by the seller.

44. The method recited in claim 10, wherein the steps of receiving, determining, and accumulating are performed only for a predetermined period of time after a sale of the computing device by the seller.

45. The computer-readable medium recited in claim 16, wherein the program code further causes the computer system to modify the stored information associating a unique identifier of a computing device with an identity of a seller when the computing device is subsequently resold by a second seller, so that the unique identifier is associated with the identity of the second seller.

46. The computer-readable medium recited in claim 19, wherein the remuneration comprises a discount against purchases of other software products or services by the seller.

47. The computer-readable medium recited in claim 23, wherein the program code causes the computer to perform the steps of receiving, determining, and accumulating only for a predetermined period of time after a sale of the computing device by the seller.

48. The computer system recited in claim 28, wherein the application modifies the stored information in the database associating a unique identifier of a computing device with an identity of a seller when the computing device is subsequently resold by a second seller, so that the unique identifier is associated with the identity of the second seller.

49. The computer system recited in claim 30, wherein the remuneration comprises a discount against purchases of other software products or services by the seller.

50. The computer system recited in claim 34, wherein the application perform the steps of receiving, determining, and accumulating only for a predetermined period of time after a sale of the computing device by the seller.
